(19) United States
(12) Patent Application Publication
(10) Pub. No.: US 2017/0161193 A1
(43) Pub. Date: Jun. 8, 2017

(54) HYBRID CACHE

(71) Applicant: INTERNATIONAL BUSINESS MACHINES CORPORATION, Armonk, NY (US)

(72) Inventor: Takanori Ueda, Tokyo (JP)

(21) Appl. No.: 14/957,178

(22) Filed: Dec. 2, 2015

(51) Int. Cl. G06F 12/08

(52) U.S. Cl. CPC G06F 12/0848; G06F 12/0895; G06F 2212/1024; G06F 2212/1044; G06F 2212/604; G06F 2212/282

(57) ABSTRACT

A hybrid cache technology with an improved performance. The hybrid cache includes an array cache area to store a first group of elements that are not replaced, and a replaceable cache area to store a second group of elements having appearance frequency lower than that of the elements in the first group. The hybrid cache may further include a control unit to adjust the boundary between the array cache area and the replaceable cache area and each of the array cache area and the replaceable cache area is composed of a plurality of regions, and the control unit adjusts the position of the boundary region between the array cache area and the replaceable cache area.

### BACKGROUND

### Technical Field

The present invention relates to improvement of a cache technology, and more particularly to a hybrid cache technology with an improved performance.

### Description of the Related Art

A cache technology has been widely used to improve computing performances of computer systems. Various cache technology and cache systems have been known so far, and among various cache systems, an application cache is widely used to improve computing performances of applications such as web applications, database applications and/or search engine applications.

Improvements of the cache system have been made as far and for example, A. El-Madhy et al. discloses in U.S. Pat. No. 8,422,821 B2 a multi-dimensional array. K. R. Desai discloses in U.S. Pat. No. 8,364,897 a cache organization with an adjustable number ways. Also S. D Biles et al. discloses in U.S. Patent Publication No. 2010/0235579 Al a cache management within a data processing apparatus. K. R. Desai et al. discloses in U.S. Pat. No. 7,996,619 B2 a K-way direct mapped cache. Furthermore, Deshpande et al. discloses in http://pages.cs.wisc.edu/˜pmd/papers/sigmod98final.pdf caching of multi-dimensional queries using chunks.

As described above, while the improvement of the cache performance has been made so far, the improvement of the cache performance in a computer technology is still requested continuously.

### SUMMARY

According to an embodiment, a hybrid cache may be provided. The hybrid cache may include an array cache area storing a first group of elements that are not replaced; and a replaceable cache area storing a second group of elements having appearance frequency lower than that of the elements in the first group.

According to an embodiment of the present invention, an access speed of the cache may be improved while saving memory capacities being allocated to the cache memory.

According to an embodiment, the hybrid cache may further include a control unit for adjusting a border between the array cache area and the replaceable cache area.

According to an embodiment of the hybrid cache, each of the array cache area and the replaceable cache area is composed of a plurality of regions, and the control unit adjusts a position of a boundary region that forms the border between the array cache area and the replaceable cache area.

According to an embodiment of the hybrid cache, the boundary region has both functions of the array cache area and the replaceable cache area, and the control unit measures the numbers of hits and misses in the array cache area and the replaceable cache area, calculates a first total access cost for a case in which the boundary region is processed only as part of the replaceable cache and a second total access cost for a case in which the boundary region is processed only as part of the array cache.

According an embodiment of the hybrid cache, the control unit, depending on the difference between the first total access cost and the second total access cost, may move the boundary region toward either the array cache area or the replaceable cache area, or retains the position of the boundary region.

According an embodiment of the hybrid cache, the elements are multi-dimensional array elements.

According to a further embodiment, a computer-implemented cache method may be provided and the method may include storing a first group of elements to an array cache area that are not replaced, and storing a second group of elements having appearance frequencies lower than that of the elements in the first group to a replaceable cache area.

According to an embodiment, a computer system implemented with cache storage may be provided and the computer system may include a processor, an array cache area storing a first group of elements that are not replaced, and a replaceable cache area storing a second group of elements having appearance frequency lower than that of the elements in the first group.

According to a further embodiment, computer program product for caching data to a hybrid cache by a processor, the computer program product including a computer readable storage medium having computer readable program code embodied therein that executes to cause the processor to perform operations may be provided and the operations may include storing a first group of elements to an array cache area that are not replaced, and storing a second group of elements having appearance frequencies lower than that of the elements in the first group to a replaceable cache area.

### BRIEF DESCRIPTION OF THE DRAWINGS

FIG. 1 shows a schematic of an example of a cloud computing node;

FIG. 2 shows an illustrative cloud computing environment;

FIG. 3 shows a set of functional abstraction layers provided by the cloud computing environment shown in FIG. 2;

FIG. 4 shows a functional block diagram of a computer system of one embodiment;

FIG. 5 shows an embodiment a cache manager part shown in FIG. 4;

FIG. 6A shows a sample embodiment of a first method for caching;

FIG. 6B shows a sample embodiments of a second method for caching;

FIG. 7 shows a schematic illustration of a data structure of a multi-dimensional array;

FIG. 8 shows relations of data appearance frequencies and indexes;

FIG. 9 shows a second embodiment of the functional structure of the cache manager part shown in FIG. 4;

FIG. 10 shows graphical representation of the second embodiment;

FIG. 11 shows a third embodiment of the cache scheme;

FIG. 12 shows a flowchart of a cache handler shown in FIG. 5;

FIG. 13 shows a flowchart of a cache handler shown in FIG. 9;

FIG. 14 shows a process executed by an allocation manager shown in FIG. 11;

FIG. 15 shows a practical computational experiment of the present invention; and

FIG. 16 shows a semi-log plot of the data shown in FIG. 15.

### DETAILED DESCRIPTION

The present invention will be described with referring to particular embodiments, however, the present invention should not be limited to the described embodiments. It should be understood in advance that although the disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

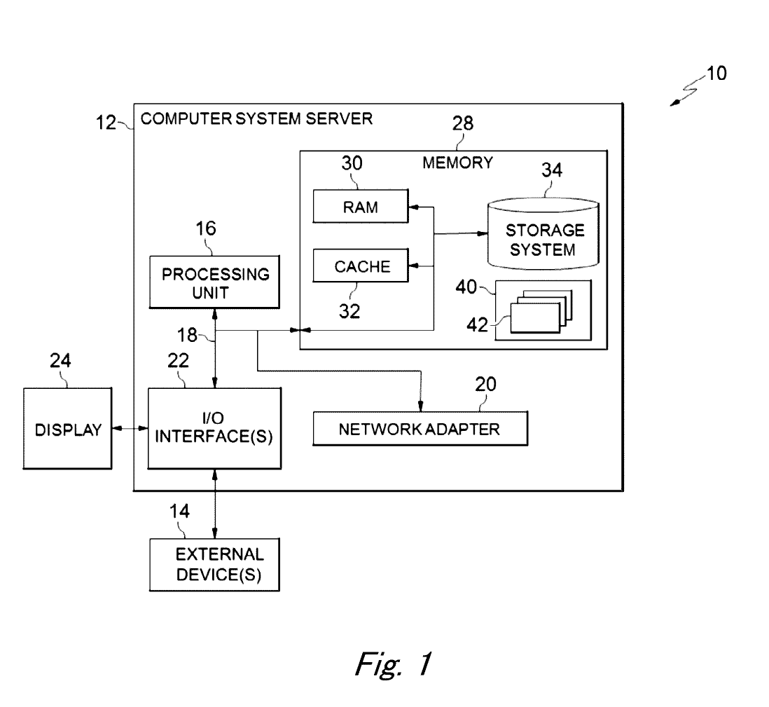

Referring now to FIG. 1, a schematic of an example of a cloud computing node is shown. Cloud computing node 10 is merely one example of a suitable cloud computing node and is not intended to suggest any limitation as to the scope of use or functionality of embodiments of the invention described herein.

Cloud computing node 10 is capable of being implemented and/or performing any of the functionality set forth hereinabove. In cloud computing node 10 there is a computer system/server 12, which is operational with numerous other general purpose or special purpose computing system environments or configurations.

Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “flexible disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. In addition, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

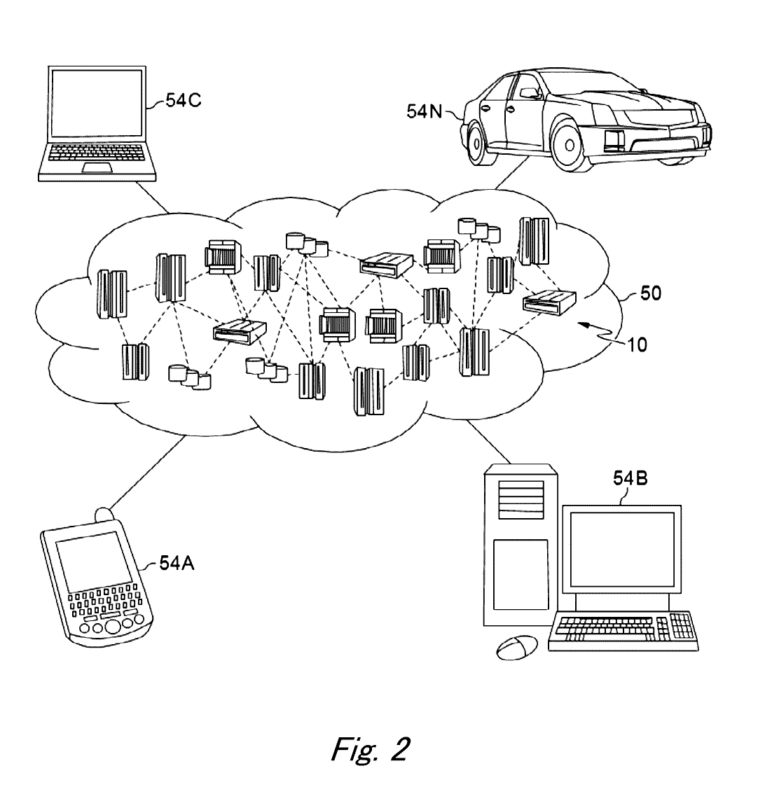

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It should be understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

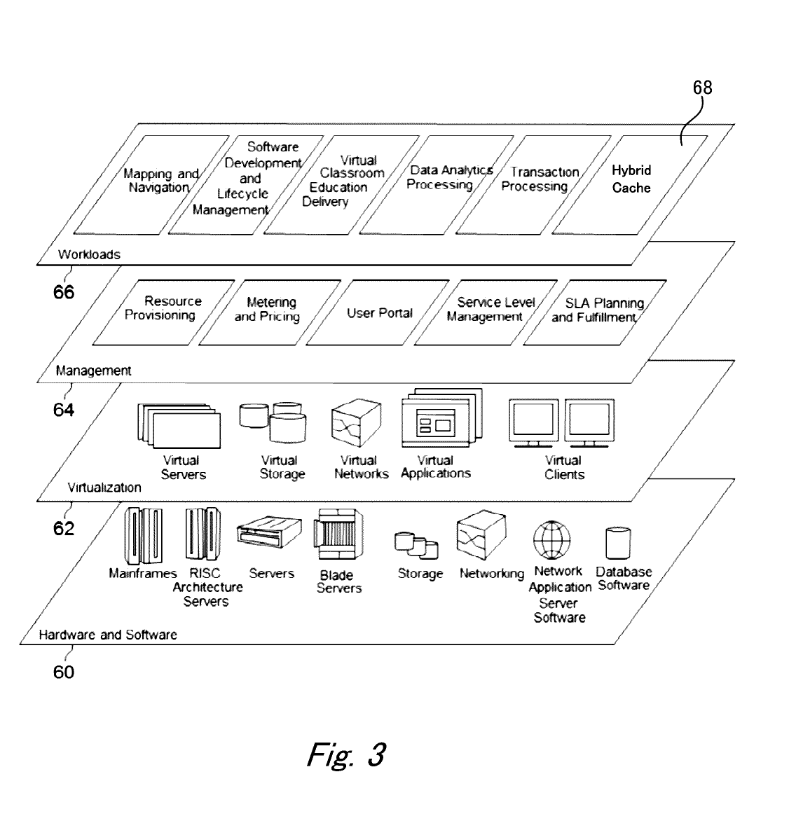

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes, RISC (Reduced Instruction Set Computer) architecture based servers, storage devices, networks and networking components. In some embodiments, software components include network application server software. Virtualization layer 62 provides an abstraction layer from which the following examples of virtual entities may be provided: virtual servers, virtual storage, virtual networks, including virtual private networks, virtual applications and operating systems, and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation, software development and lifecycle management, virtual classroom education delivery, data analytics processing, transaction processing, and the Hybrid caching 68 of embodiments of the present invention.

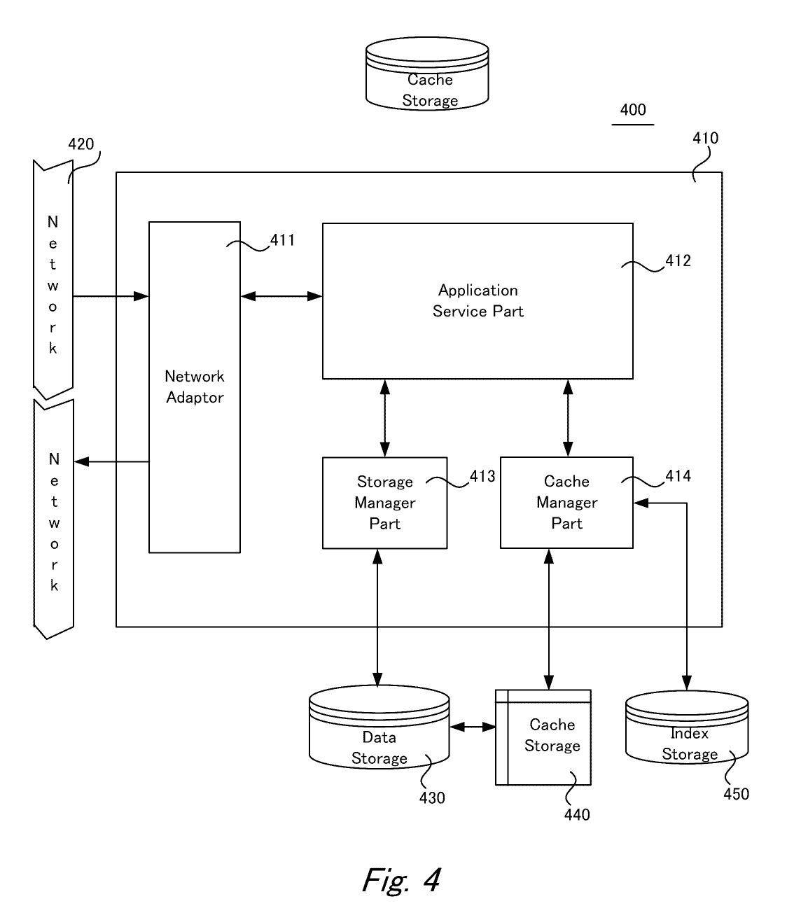

FIG. 4 shows a functional block diagram of a computer system of one embodiment. The functional blocks of FIG. 4 may be realized on the computer system by executing program codes with the processor unit 16 through cooperative functions of the software and hardware. The computer system 400 includes a network adaptor 411 and the network adaptor 411 may receive requests and/or instructions from remote computers through the network 420 such as for example Internet and/or LAN. The computer system 400 includes the application service part 412 and the application service part 412 provides various services in response to the requests and/or instruction. The application service part 412 may include an application for executing programs for the service and returns results of computation to the remote computers through the network 420.

The embodiment of the computer system includes the storage manager part 413 and the cache manager part 414. The storage manager part 413 may manage the data storage 430, such as a hard disk drive, which stores data, programs, and/or results of computation for the computation of the computer system. The cache manager part 414 may manage data caching to the cache storage 440, such as so called “level n” or “application” caches included in the processor, RAM, and/or SSD which may provide fast access to the data. It should be noted that the cache storage 440 is implemented in a fast access storage, such as a physical memory localized in the computer system and/or other fast access storage available through a distributed system and the cache storage per se does not include an element of the cache manager part 414. Also the cache manager part 414 may manage the index storage 450. The index storage 450 stores index values allocated to variables used by the computation of the application service part 412.

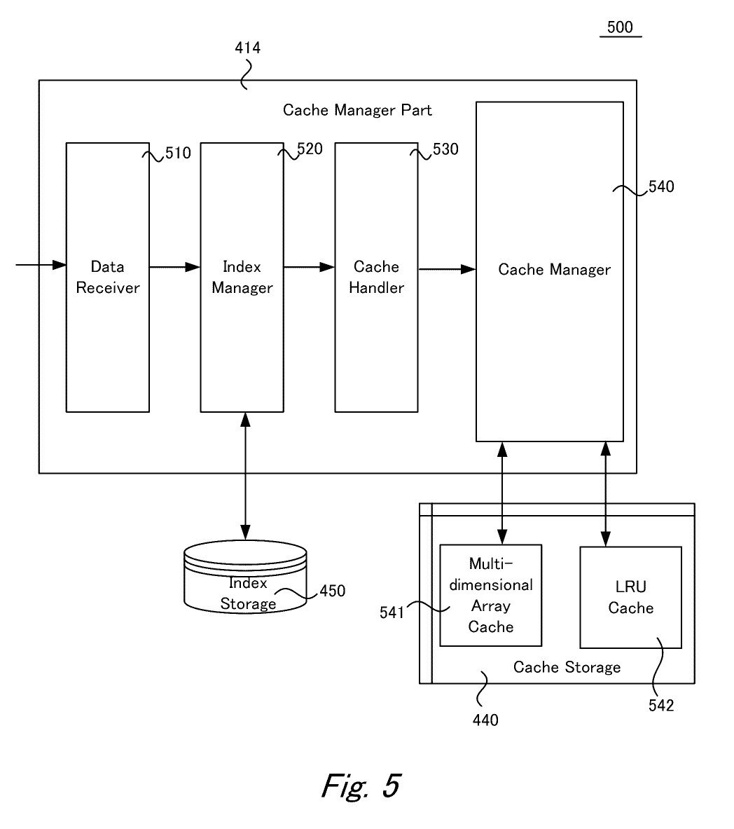

FIG. 5 shows an embodiment of the detailed functional structure 500 of the cache manager part 414. The cache manager part 414 includes, according to an embodiment the data receiver 510, the index manager 520 and the cache handler 530. The cache manager part 414 may correspond to a controller unit managing the caching mechanism of this embodiment. The data receiver 510 receives various data contents used for the computation of the application program and sends the data contents to the index manager 520. The index manager 520 searches the index for each received data content from the index storage 450. When the index manager 520 finds the index for a data content, the index manager 520 sends the index and the data content to the cache handler 530. When the index manager 520 fails in finding the index for the data content, the index manager 520 may assign a new index value to the data content depending on the particular statistics of the data content.

The cache handler 530 stores the data content to the cache storage 440. Also the cache handler 530 checks the index of the data content. The cache handler 530 instructs the cache manager 540 to register the data content in a multi-dimensional array cache or in a replaceable cache, which may be an LRU (Least Recently Used) cache, depending on the appearance frequency. To simplify the explanation, when the term “multi-dimensional” is used, it is intended to include “one-dimensional”. In this embodiment, a 2-dimensional array is used because the number of dimensions in this embodiment is 2. However, the number of dimensions is not limited to 2. If the number of dimensions is 1 in another embodiment, a 1-dimensional array may be used. More generally, an n-dimensional array may be used if the number of dimensions is n. The cache manager 540 manages cache data structures implemented by the multi-dimensional array cache 541 and the LRU cache 542. The multi-dimensional array cache 541 can be implemented by using, but not limited to, an array type provided in programming languages. In the example embodiment shown in FIG. 5, the multi-dimensional array cache 541 caches data contents that have higher appearance frequencies than those of data contents cached in the LRU cache 542. The LRU cache 542 replaces a data content that is least recently used with an incoming data content when the LRU cache is full. The multi-dimensional array cache 541 does not replace any data content because it pre-allocates the memory space for all of the data contents to be cached in the array. The detail of the caching strategy will be discussed later.

Now, the computation of the application program may be generally expressed as the following formula (1):

c=f(x₁, x₂, . . . , xₛ)(x₁ ε X₁, x₂ ε X₂, . . . , xₛ ε Xₛ), (1)

wherein xᵢ (i=1, . . . , s) is a variable in a coordinate Xᵢ and c is the result of the computation; one set of s variables and the computation result may be referred in this description to the term “data content” managed by the cache.

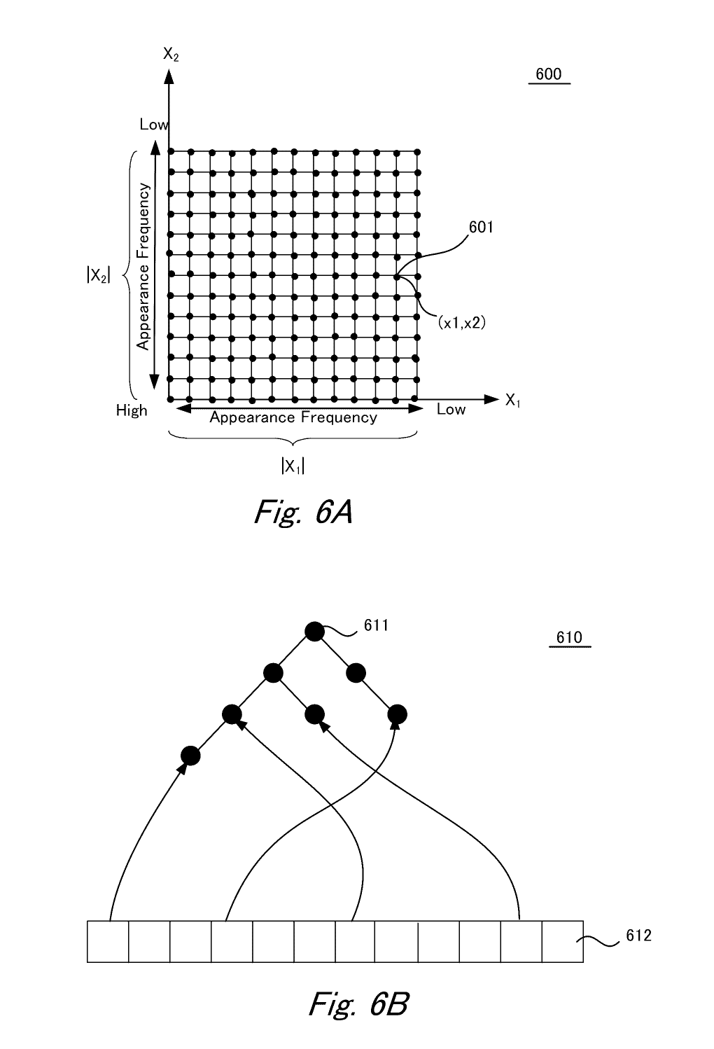

FIGS. 6A and 6B show sample embodiments of two methods for caching. FIG. 6A shows the data structure of the multi-dimensional array cache 541 simplified to 2 dimensions (x₁ and x₂). FIG. 6B shows the data structure of the LRU cache 542. In an embodiment, the 2-dimension space may be divided into first and second regions, and the boundary of the two regions may be changed depending on appearance frequencies of the data contents. In a sample embodiment, the above two cache methods are executed by the computer system as formula (2):

If IDₛ(x)<q(1≦s≦S), then cache x to the multi-dimensional array cache;

If q≦IDₛ(x)(1≦s≦S), then cache x to the LRU cache; (2)

wherein IDₛ(x) returns the index of the data content x and the parameter q defines the border of the above first and second regions. The parameter q may also provide a function to determine the cache capacity and cache performance; larger q reduces the average latency of an access to the cache because the multi-dimensional array that provides smaller access latency than LRU cache covers a larger space while the cache size becomes larger. Smaller q increases the average latency of an access to the cache because the LRU cache that poses longer latency than the multi-dimensional cache covers a larger space while the cache size becomes smaller.

In FIG. 6A, the structure of the multi-dimensional array cache is shown. A multi-dimensional array provided in common programming languages can be typically used to implement the multi-dimensional array cache. The coordinate system of the multi-dimensional array cache 600 is defined by the coordinates aligned to the indexes in ascending order of the appearance frequencies of variables on X₁ and X₂ toward the origin. The result calculated from the variables x₁ and x₂ 601 may be cached to the element (x₁, x₂) of the multi-dimensional array in the cache storage 440. When the same calculated result is requested next time, the cached data in the cache storage 440 should be referred without the re-computation. Furthermore, the cached data in the cache storage 440 should be referred with very short latency because of the short access latency to an element of the multi-dimensional array. However, the cache structure of FIG. 6A requires a large memory space as high as O|X₁∥X₂| because the multi-dimensional array can occupy the memory space to cache all of the coordinate system.

FIG. 6B shows the data structure of the LRU cache 610. It consists of a LRU list 612 and a search tree 611 used to lookup a cached data content from the LRU list 612. The LRU cache 610 caches the data content in the cache storage 440 by using the LRU list 612. The cache manager part 414 can control the memory space required for the LRU cache 610 by limiting the number of cached contents. When the number of the cached contents reaches to the limit, e.g., when the LRU cache 610 is full, the contents in the cache storage 440 are evicted in the least recent used order (LRU). Thus, the LRU cache 610 occupies the memory space proportional to the limited number of the cached contents. However, the search tree 611 poses a longer latency than that of multi-dimensional array cache 600 when looking up a cache content.

In one embodiment, the cache manager part 414 divides the cache space into two regions. The first region may be cached by the multi-dimensional array cache 541 and the other region may be cached by the LRU cache 542 shown in FIG. 5.

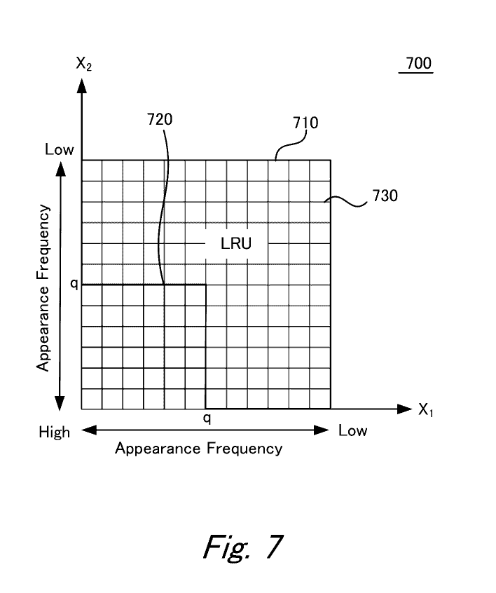

FIG. 7 shows a schematic illustration of an embodiment of the data structure of the cache 700. The cache architecture utilizing the multi-dimensional array cache 600 and the LRU cache 610 may be referred herein as “Hybrid Cache” or “Hybrid Cache System”. The multi-dimensional array 720 includes a matrix in the illustrated embodiment. According to one embodiment, the residual unhatched region 720, e.g., the first region, is allocated to the multi-dimensional array cache 541, and the hatched region 730, e.g., the second region, is cached by the LRU cache 542.

The indexes of data contents are ordered in ascending order of their appearance frequency toward the origin. This means that the data with higher appearance frequencies, which correspond to have small index values, should be cached in the multi-dimensional array cache 541, e.g., in the first region. On the other hand, the data with lower appearance frequencies may be cached by using the LRU cache 542, e.g., in the second region.

The above caching scheme may improve access latencies to the data contents of which appearance frequencies in the computation are high because of the low latency access to the cached contents in the multi-dimensional array. The data contents with less appearance frequencies are cached by using the LRU scheme to reduce the cache memory size rather than caching all of the contents to the multi-dimensional array.

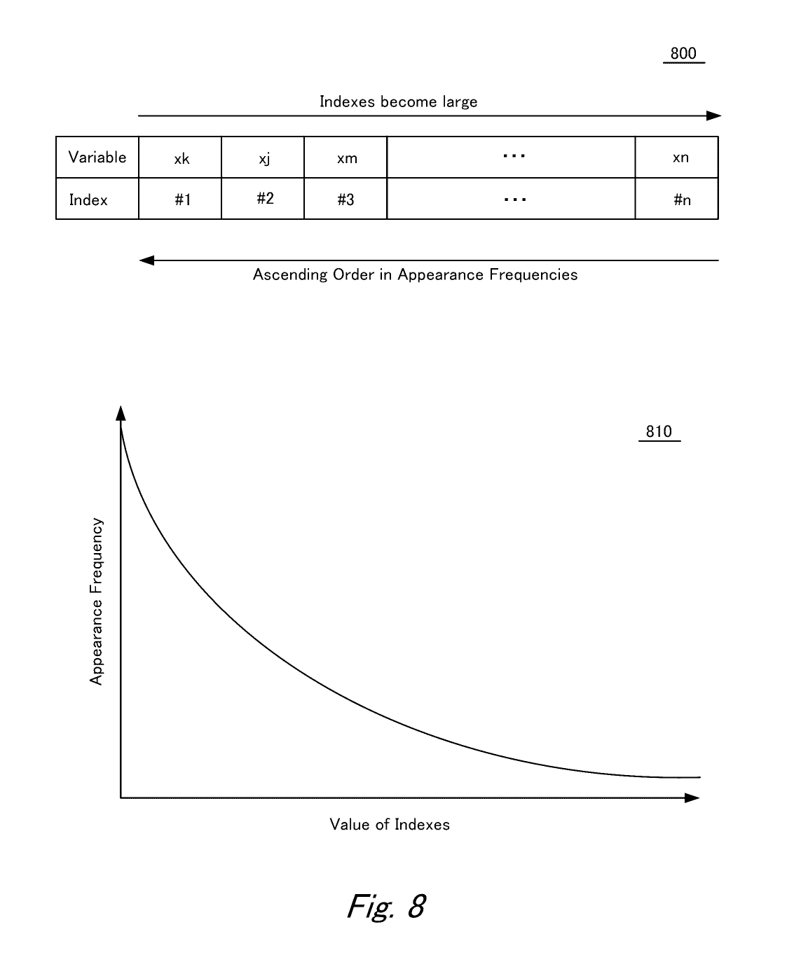

FIG. 8 shows relations of the data appearance frequencies and the indexes. The variables may be collected beforehand by using adequate computer systems to allocate the indexes. The data with higher appearance frequencies are allocated with lower numeral indexes such as #1, #2, #n, as shown in table 800. The appearance frequencies and the indexes may, for example, be related to some mathematical functions providing the relation 810. The mathematical function may be not limited to a particular function and any mathematical function may be used such that the mathematical function may provide the low index value to the variables with higher appearance frequencies.

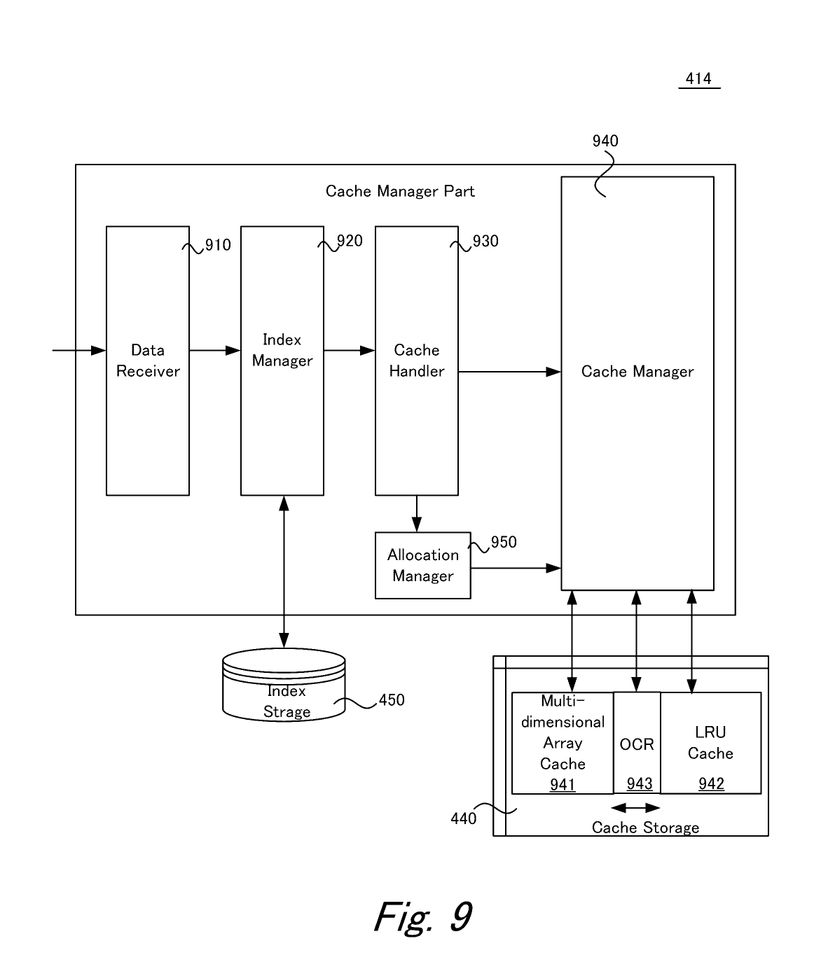

FIG. 9 shows a second embodiment of the functional structure of the cache manager part 414, e.g., the controller unit. The data receiver 910, the index manager 920, and the cache handler 930 have the same functions with the data receiver 510, the index manager 520, and the cache handler 530, respectively. Therefore, further description will be omitted. The cache manager part 414 of the embodiment of FIG. 9 includes the cache manager 940 in which the multi-dimensional array cache 941 and the LRU cache 942 are provided. In the embodiment of FIG. 9, the overlapped cache region Rᵢ (i=1, . . . , N) of the multi-dimensional array cache 941 and the LRU cache 942 is defined. In FIG. 9, the overlapped cache region 943 is referred as OCR 943. In the overlapped cache region 943, data contents may be cached by both of the multi-dimensional array cache 941 and the LRU cache 942. As stated in the foregoing paragraph, it should be noted that the cache storage 440 is implemented in a fast access storage, such as a physical memory localized in the computer system and/or other fast access storage available through a distributed system and the cache storage per se does not include an element of the cache manager part 414 of the embodiment shown in FIG. 9.

This embodiment may be attained by creating the overlapped region 943. In addition, the multi-dimensional array cache scheme may have priority to access to the cache contents in the overlapped cache region 943 to reduce the cache latencies rather than accessing the LRU cache 942. In an embodiment of FIG. 9, in order to create the overlapped region 943, the cache handler 930 examines the indexes and determines the cache structures for the cache according to the following formula (3):

If IDₛ(x)<pᵣ(1≦s≦S), then cache x to the multi-dimensional array cache;

If pᵣ≦IDₛ<pᵣ₊₁(1≦s≦S), then cache x to both of the multi-dimensional array cache and the LRU cache;

If pᵣ₊₁≦IDₛ(x)(1≦s≦S), then cache x to the LRU cache, (3)

wherein IDₛ(x) represents the index value of data content x on the coordinate s and pᵣ is the index of the lower edge of the overlap region Rᵣ and the pᵣ₊₁ is the upper edge of the overlap region.

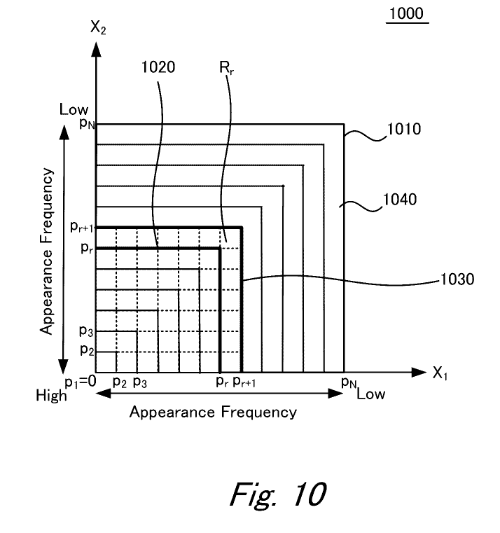

FIG. 10 shows a graphical representation of the second embodiment. The indexes pᵢ (i=1, . . . , N) are aligned in ascending order of the appearance frequencies from p₁ to p_{N} toward the origin. The maximum capacity of the cache is indicated by the border 1010. The inside region from the border 1020 may be managed by the multi-dimensional array cache 941. The region from the border 1030 to the border 1010 may be managed by the LRU cache 942.

In the embodiment shown in FIG. 10, the overlap region Rᵣ is the region between the border 1020 and the border 1030. In this region, data contents are cached by using the two cache mechanisms. One advantage for defining the overlap region Rᵣ is simply to enlarge the multi-dimensional array cache region and furthermore to provide flexible capacity changes for two cache mechanisms depending on cache efficiency.

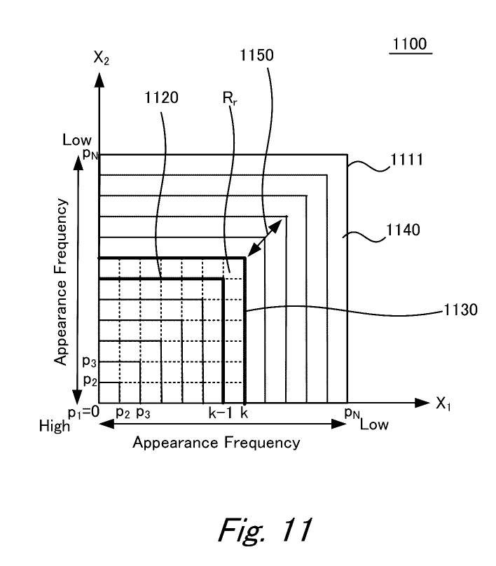

FIG. 11 shows a third embodiment of the cache scheme and the third embodiment may change capacities of the first region and the second region depending on the cache latency or statistical cache efficiency as illustrated by the arrow 1150. Now, the third embodiment will be described in detail. Here, let Rᵢ (i≧1) be the region between pᵢ≦IDs≦pᵢ₊₁(1≦s≦S). An LRU cache covers the LRU cache region 1140 and the overlapped region Rᵣ in the cache system. Furthermore, a new variable k, which defines the outer border of the overlap region Rᵣ, is defined.

Further then, cache access costs of the multi-dimensional array region Rᵢ (i≦k−1) and the LRU region Rᵢ (i≧k+1) may be calculated statistically by using the following parameters (4):

Number of cache hits in the array region Rᵢ: hᵢ^{array}

Number of cache misses in the array region Rᵢ: mᵢ^{array}

Number of hits in the LRU region Rᵢ: hᵢ^{lru}

Number of misses in the LRU region Rᵢ: mᵢ^{lru}

Number of elements in the LRU in region Rᵢ: eᵢ^{lru} (4)

In each of the regions, the value (hᵢ+mᵢ) provides the total number of access to each of the regions. In the region Rₖ, which corresponds to the overlap region, all of the above statistics for the array and the LRU should be collected.

Access costs to the caches may be defined by the parameters wₐ, wₗ, and w_{c}, where wₐ represents the cost of an access to the array cache, wₗ represents the cost of an access to the LRU cache, and w_{c} represents the cost of a calculation on a cache miss, respectively. The total access costs when the region Rₖ is managed only by the LRU cache Cₖ₋₁, and when the region Rₖ is managed only by the multi-dimensional cache Cₖ are computed as follows:

Cₖ₋₁=Σᵢ₌₀^{k-1}(hᵢ^{array}wₐ+mᵢ^{array}w_{c})+Σᵢ₌ₖ^{N}(hᵢ^{lru}wₗ+mᵢ^{lru}w_{c})

Cₖ=Σᵢ₌₀^{k}(hᵢ^{array}wₐ+mᵢ^{array}w_{c})+L(k+1), (5)

wherein the function L(k+1) provides the access costs for the region Rᵢ (i≧k+1) by the LRU cache using the statistics of accesses to the region Rᵢ (i≧k) managed by the LRU list.

The function L(k) may be exemplary provided as, following consideration, but not limited to, any equivalent functions may be replaced to the function L(k+1). Now, a parameter Mₖ^{lru} may be defined as the number of data contents that the LRU cache can hold when r=k. It may be reasonably assumed Mₖ^{lru}>Mₖ₊₁^{lru} because the cache system has to decrease the capacity of the LRU cache when increasing the region cached by the multi-dimensional cache with keeping the total size of the cache.

When the cache system changes the parameter r from k to k+1, e.g., the LRU cache no longer caches data contents in the current overlap region, the LRU cache evicts the Mₖ^{lru}−Mₖ₊₁^{lru}) data contents cached in the LRU cache at maximum. The LRU cache evicts in its nature the data contents which are not recently accessed, that is to say, the LRU scheme evicts the data contents having long interval from the prior access.

The indexes are assigned to data contents in the ascending order of the appearance frequencies in the embodiments and, thus, the data contents farthest from the origin of the coordinate system may be reasonably assumed not accessed long such that the data contents to be evicted may be the data contents in the farthest locations upon changing the parameter r from r=k to r=k+1. From the above consideration, the function L(k+1) may be obtained by summation of the access costs of remaining entries and the access costs of the evicted entries. Thus, the function L(k+1) may be provided as following formula (6):

$$L ( k + 1 ) = {\sum }_{\{ k + 1 \leq j \leq N \vert {\sum }_{i = k + 1}^{j} {e}_{i}^{lru} \leq {M}_{k + 1}^{lru} \}} ( {h}_{j}^{lru} {w}_{l} + {m}_{j}^{lru} {w}_{c} ) + {\sum }_{k + 1 \leq j \leq N \vert {\sum }_{i = k + 1}^{j} {e}_{i}^{lru} > {M}_{k + 1}^{lru}} ( {h}_{j}^{lru} + {m}_{j}^{lru} ) {w}_{c} \qquad ( 6 )$$

The capacity change in two cache schemes may be performed according to the algorithm as follows:

If Cₖ₋₁−Cₖ>ε, then r=k+1; #Expansion of the array region

If Cₖ−Cₖ₋₁>ε, then r=k−1; #Shrink of the array region (7)
else r=k; #keep the sizes of the regions,
wherein ε is a given threshold for the access cost.

According to the above algorithm and the presence of the overlapped region, the sizes of the first region and the second region may be changed without loss of the data contents that have relatively high access frequencies.

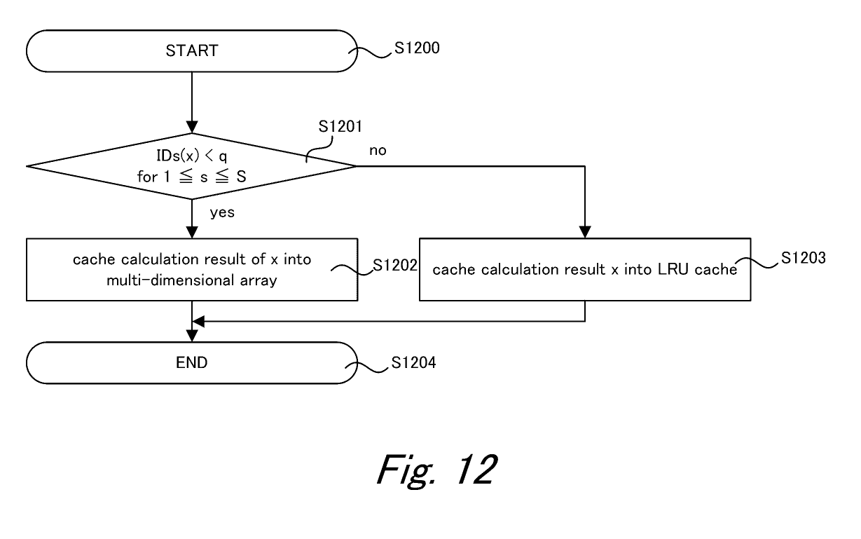

FIG. 12 shows a flowchart of the cache handler 530 in the first embodiment. The cache handler 530 starts its process from step S1200. Then the cache handler 530 determines whether or not IDs (x) is less than q for every dimension (1≦s≦S) in step S1201. When IDs(x)<q(yes), the cache handler 530 caches calculation result x into the multi-dimensional array cache in step S1202.

When IDs(x) is not less than q (no), the cache handler 530 caches the calculation result x into the LRU cache and updates the LRU list in step S1203. The cache handler 530 terminates its process after caching the variable x in step S1204. By the method shown in FIG. 12, the Hybrid cache structure may be generated.

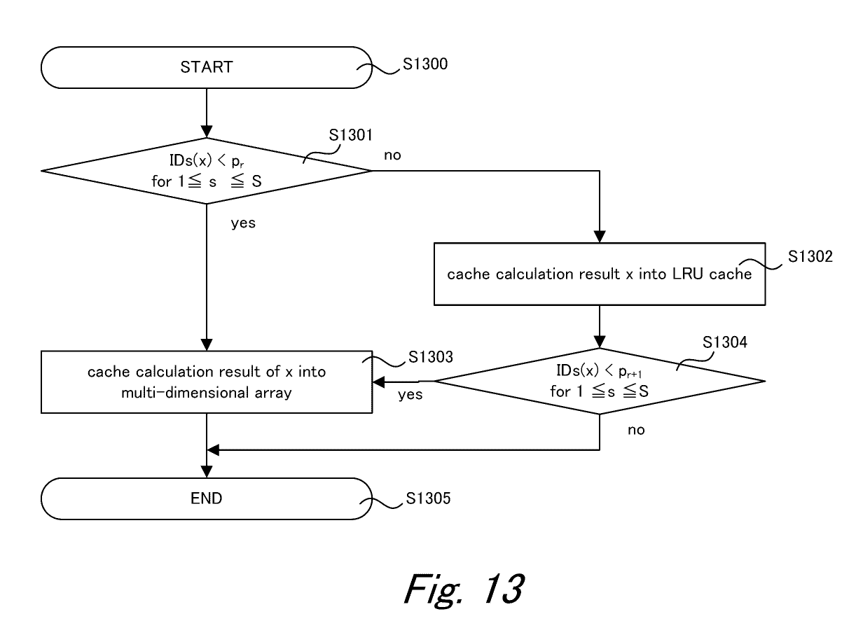

FIG. 13 shows a method of the cache handler 930 in the second embodiment. The cache handler 930 starts its process from step S1300. In step S1301, the cache handler 930 determines whether or not IDs (x) is less than pᵣ for every dimension (1≦s≦S).

When IDs(x)<pᵣ (yes), the cache handler 930 caches x into the multi-dimensional array cache in step S1304. When IDs(x) is not less than pᵣ (no), the cache handler 930 caches the calculation result x into the LRU cache and updates the LRU list in step S1302. Further then the cache handler 930 determines whether or not IDs(x) is less than pᵣ₊₁. When IDs(x) is less than pᵣ₊₁ (yes), the process diverts to step S1303 to cache the calculation result x into the multi-dimensional array and process pass the control to step S1305 to end. When the determination in step S1304 returns a negative result (no), the process of the cache handler 930 terminates in step S1305.

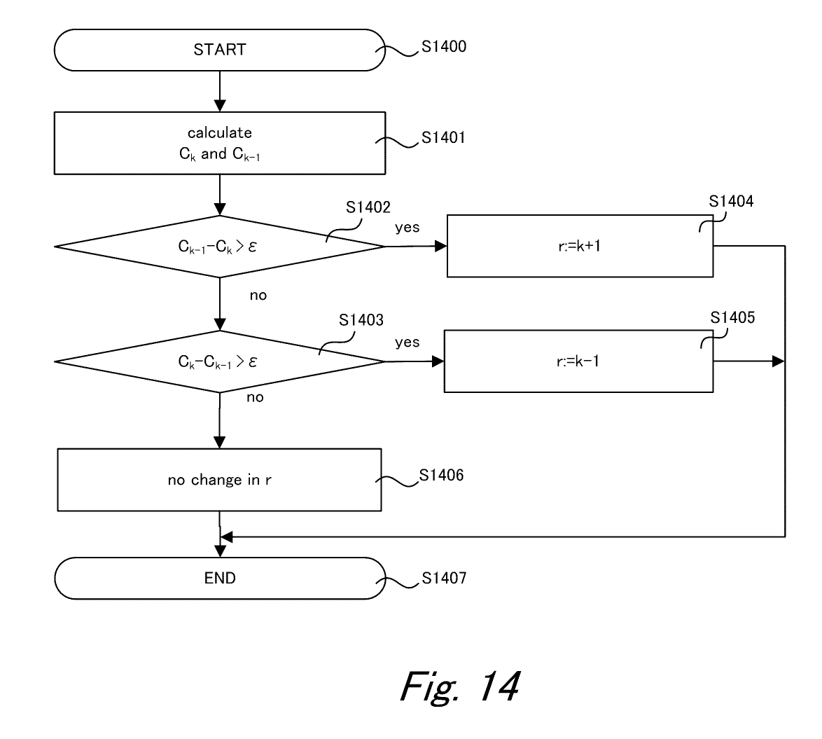

According to the caching strategy described in FIG. 13, the overlap region of the multi-dimensional array region and the LRU cache region may be generated and then, it may be possible to expand and shrink the cache regions depending flexibly on system requirements, as described below with referring to FIG. 14.

FIG. 14 shows a method executed by the allocation manager 950 in the third embodiment. The process of the allocation manager 950 starts from step S1400 and in step S1401 the allocation manager 950 calculates the values of Cₖ and Cₖ₋₁ according to the formula (5). Then the allocation manager 950 determines whether or not Cₖ₋₁−Cₖ is larger than ε in step S1402.

When the determination in step S1402 returns the affirmative result (yes), the allocation manager 950 sets the value r=k+1 in step S1404, and the allocation manager 950 terminates its process in step S1407. When the determination in step S1402 returns the negative result (no), the allocation manager 950 in step S1403 determines whether or not Cₖ−Cₖ₋₁ is larger than ε. When the determination in step S1403 returns the affirmative result, the allocation manager 950 sets the value r=k−1 in step S1405 and the allocation manager 950 terminates its process in step S1407.

When the determination in step S1403 returns the negative result (no), then the allocation manager 950 makes no change in the value r to keep the region sizes in the step S1406 and then terminates its process in step S1407. The allocation manager 950 makes it possible to change flexibly the multi-dimensional array cache and the LRU cache such that the cache mechanism may be optimized depending on practical cache accesses in particular computer system.

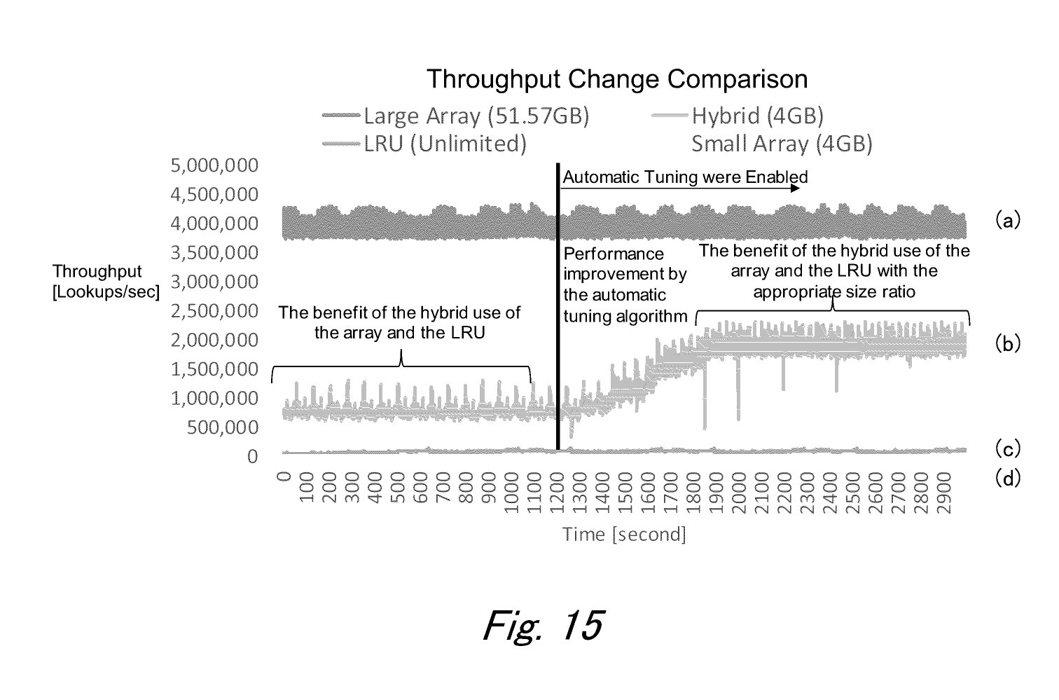

FIG. 15 shows a practical computational experiment of the present invention. The computational experimentation was performed under the following conditions:
(1) Application: Word Sense Disambiguation (WSD) (http://dl.acm.org/citation.cfm?id=972721, Aug. 3, 2015 downloaded from Internet) that deduces the meaning of words. In the application, IDs was allocated to the words in the ascending order corresponding to the appearance frequency in Google Books Ngram.
(2) Measure of evaluation: The throughput of the computation was monitored every one second.
(3) Memory Limits:
Multi-Dimensional Array (comparative): 51.57 GB: (All data is cached)
LRU: Unlimited (comparative)
Hybrid (present invention): 4 GB: (Initially, 800 MB was allocated to the array)
Small Array (comparative): 4 GB: (only partial data is cached)

As shown in FIG. 15, the large array (a) provided the highest performance while requiring huge memory sizes 51.57 GB. The LRU cache showed relatively poor performance compared to the large array though the memory consumptions were low (c). The small array with limited memory sizes shown by (d) showed the worst performance. The present embodiment hybrid cache system shown by (b) showed improvements in the computation efficiency. Then, when the automatic parameter tuning mechanism was enabled, the computation performance markedly improved while the memory consumption was the same with the small array (d)

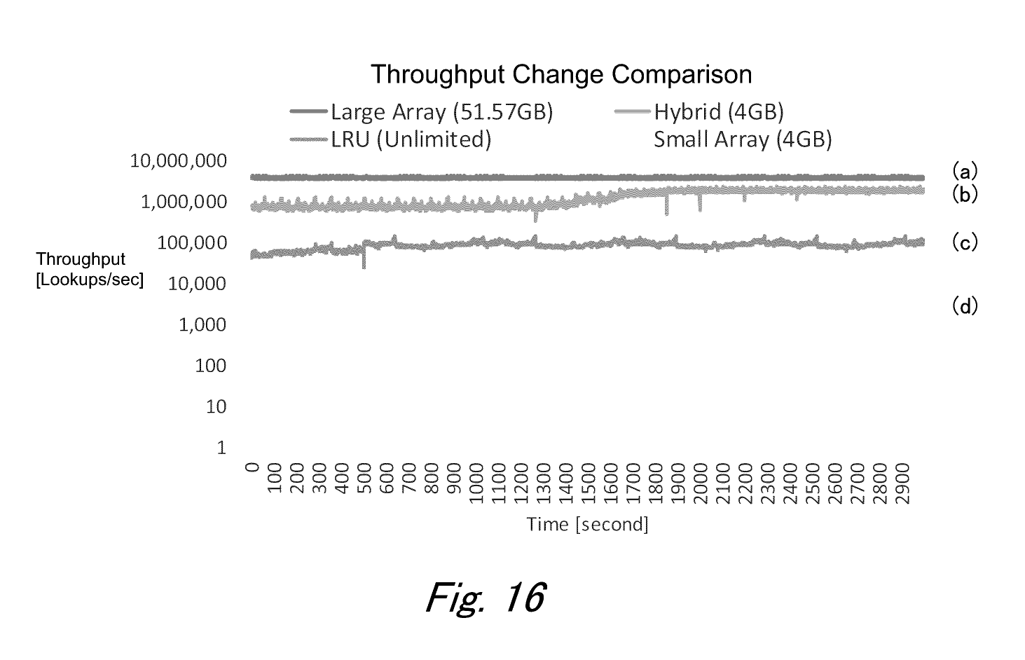

FIG. 16 shows a semi-log plot of the data shown in FIG. 15. FIG. 16 clearly shows the improvements in the low performance area. As understood by the plots of FIG. 16, the embodiments disclosed herein may reduce the cache memory consumption while keeping the computation performances in the acceptable level that was about the half of the performance of the large array.

As described in the above, the computer system according to the present invention achieves both fast access speed of the multi-dimensional array and the memory efficiency of LRU list while improving the throughput by automatically adjusting the memory allocation to the two data structures.

The present invention may be widely applicable to web applications provided through the network, database applications, search engine applications, and/or various cloud computation as well as conventional scientific computations for improving the computation performance and quality of the computation while providing proper hardware investments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers.

A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A hybrid cache, comprising:
an array cache area to store a first group of elements that are not replaced; and
a replaceable cache area to store a second group of elements having appearance frequency lower than that of the elements in the first group.

2. The hybrid cache of claim 1, further comprising a control unit to adjust a border between the array cache area and the replaceable cache area.

3. The hybrid cache of claim 2, wherein:
each of the array cache area and the replaceable cache area is composed of a plurality of regions; and
the control unit adjusts a position of a boundary region that forms the border between the array cache area and the replaceable cache area.

4. The hybrid cache of claim 3, wherein:
the boundary region includes functions of the array cache area and the replaceable cache area; and
the control unit measures numbers of hits and misses in the array cache area and the replaceable cache area, calculates a first total access cost when the boundary region is processed only as part of the replaceable cache area and a second total access cost when the boundary region is processed only as part of the array cache area.

5. The hybrid cache of claim 4, wherein the control unit, depending on a difference between the first total access cost and the second total access cost, moves the boundary region toward either the array cache area or the replaceable cache area, or retains the position of the boundary region.

6. The hybrid cache of claim 1, wherein the elements of the first group are multi-dimensional array elements.

7. A computer-implemented cache method for caching data to a hybrid cache, comprising:
storing a first group of elements to an array cache area that are not replaced; and
storing, using a cache manager, a second group of elements having appearance frequencies lower than that of the elements in the first group to a replaceable cache area.

8. The method of claim 7, further comprising:
adjusting, using a control unit, a border between the array cache area and the replaceable cache area.

9. The method of claim 8, wherein:
each of the array cache area and the replaceable cache area is composed of a plurality of regions; and
the adjusting step includes adjusting a position of a boundary region that forms the border between the array cache area and the replaceable cache area.

10. The method of claim 9, wherein:
the boundary region includes functions of the array cache area and the replaceable cache area; and
the adjusting step further comprises:
measuring numbers of hits and misses in the array cache area and the replaceable cache area;
calculating a first total access cost when the boundary region is processed only as part of the replaceable cache area and a second total access cost when the boundary region is processed only as part of the array cache area; and
depending on a difference between the first total access cost and the second total access cost, moving the boundary region toward either the array cache area or the replaceable cache area, or retaining the position of the boundary region.

11. The method of claim 6, wherein the computer-implemented method provides cloud computing capabilities.

12. The method of claim 6, wherein the elements of the first group are multi-dimensional array elements.

13. A computer system implemented with cache storage, the computer system comprising:
a processor;
an array cache area to storine a first group of elements that are not replaced; and
a replaceable cache area to store a second group of elements having appearance frequency lower than that of the elements in the first group.

14. The computer system of claim 13, wherein the computer system further comprises a control unit to adjust a border between the array cache area and the replaceable cache area.

15. The computer system of claim 14, wherein:
each of the array cache area and the replaceable cache area is composed of a plurality of regions; and
the control unit adjusts a position of a boundary region that forms the border between the array cache area and the replaceable cache area.

16. The computer system of claim 15, wherein:
the boundary region includes functions of the array cache area and the replaceable cache area; and
the control unit measures numbers of hits and misses in the array cache area and the replaceable cache area, calculates a first total access cost when the boundary region is processed only as part of the replaceable cache area and a second total access cost when the boundary region is processed only as part of the array cache area.

17. The computer system of claim 16, wherein the control unit, depending on a difference between the first total access cost and the second total access cost, moves the boundary region toward either the array cache area or the replaceable cache area, or retains the position of the boundary region.

18. The computer system of claim 13, wherein the elements of the first group are multi-dimensional array elements.

19. A computer program product for caching data to a hybrid cache by a processor, the computer program product comprising a computer readable storage medium having computer readable program code embodied therein that executes to cause the processor to perform a method, the method comprising:
storing a first group of elements to an array cache area that are not replaced; and
storing, using the processor, a second group of elements having appearance frequencies lower than that of the elements in the first group to a replaceable cache area.

20. The computer program product of claim 19, wherein the method further comprises:
adjusting, using a control unit, a border between the array cache area and the replaceable cache area.

21. The computer program product of claim 20, wherein:
each of the array cache area and the replaceable cache area is composed of a plurality of regions; and
the adjusting step includes adjusting a position of a boundary region that forms the border between the array cache area and the replaceable cache area.

22. The computer program product of claim 21, wherein:
the boundary region includes functions of the array cache area and the replaceable cache area; and
the adjusting step further comprises:
measuring numbers of hits and misses in the array cache area and the replaceable cache area;
calculating a first total access cost when the boundary region is processed only as part of the replaceable cache area and a second total access cost when the boundary region is processed only as part of the array cache area; and
depending on a difference between the first total access cost and the second total access cost, moving the boundary region toward either the array cache area or the replaceable cache area, or retaining the position of the boundary region.

23. The computer program product of claim 19, wherein the elements of the first group are multi-dimensional array elements.
